(19) United States
(12) Patent Application Publication
(10) Pub. No.: US 2004/0225870 A1
(43) Pub. Date: Nov. 11, 2004

(54) Method and apparatus for reducing wrong path execution in a speculative multi-threaded processor

(76) Inventors: Srikanth T. Srinivasan, Beaverton, OR (US); Haitham H. Akkary, Portland, OR (US)

Correspondence Address: Dennis A. Nicholls, BLAKELY, SOKOLOFF, TAYLOR & ZAFMAN LLP, Seventh Floor, 12400 Wilshire Boulevard, Los Angeles, CA, 90025, US

(21) Appl. No.: 10/431,992

(22) Filed: May 7, 2003

(51) Int. Cl. G06F 9/44

(52) U.S. Cl. 712/235; 712/239

(57) ABSTRACT

A method and apparatus for reducing wrong path execution in a speculative multi-threaded processor is disclosed. In one embodiment, a wrong path predictor may be used to enhance the selection of the right path at a branch point. In one embodiment, the wrong path predictor may include a speculative processor to produce a speculative processor execution outcome, and a branch corrector to determine whether to trust the speculative processor execution outcome. The branch corrector may be used to choose between using the speculative execution, or, instead, overriding the speculative execution with the non-speculative branch prediction.

### FIELD

The present disclosure relates generally to microprocessor systems, and more specifically to microprocessor systems capable of speculative multi-threaded execution.

### BACKGROUND

In order to enhance the processing throughput of microprocessors, processors capable of executing multiple-threads may execute more than one thread from a single application simultaneously. When the primary non-speculative execution is diverted into a procedure call or a loop, a subsequent thread could be spawned to speculatively execute code after the call or loop. When the non-speculative execution reaches the spawn point of the subsequent thread, much of the processing performed in the speculative execution may be hopefully reused, without having to re-execute. In this manner the non-speculative execution may advance at a more rapid rate than otherwise.

One of the design challenges of speculative execution is not knowing whether or not the registers being modified by non-speculative execution will affect the outcomes computed by the speculative execution. This makes invalid the speculative execution of those instructions using those registers. In the case that the instruction is a branch instruction, not only will the specific instruction have invalid results, but also all the subsequent instructions on the wrongly-chosen path will have invalid results. Therefore it is a significant design challenge to reduce the number of wrongly-chosen paths during speculative execution.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of an apparatus with a speculative processor and a non-speculative processor, according to one embodiment.

FIG. 2 is a diagram of speculative execution during a non-speculative routine, according to one embodiment.

FIG. 3A is a schematic diagram of a wrong path predictor circuit, according to one embodiment of the present disclosure.

FIG. 3B is a schematic diagram of a wrong path predictor circuit, according to another embodiment of the present disclosure.

FIG. 4 is a schematic diagram of a chooser logic of FIG. 3, according to one embodiment of the present disclosure.

FIG. 5A is a diagram of a pattern history table of FIG. 4, according to one embodiment of the present disclosure.

FIG. 5B is a logic table of a counter of FIG. 5A, according to one embodiment of the present disclosure.

FIG. 6 is a flowchart of determining how to train a wrong path predictor, according to one embodiment of the present disclosure.

FIG. 7 is a schematic diagram of a multi-processor system, according to another embodiment of the present disclosure.

### DETAILED DESCRIPTION

The following description describes techniques for predicting when a speculative processor should follow a branch path calculated in the speculative processor's execution, and when it should instead follow a branch path determined by a non-speculative branch predictor. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a processor module with a speculative processor and a non-speculative processor. However, the invention may be practiced in other forms of processors, such as in single processors that may execute multiple threads including speculative threads and non-speculative threads.

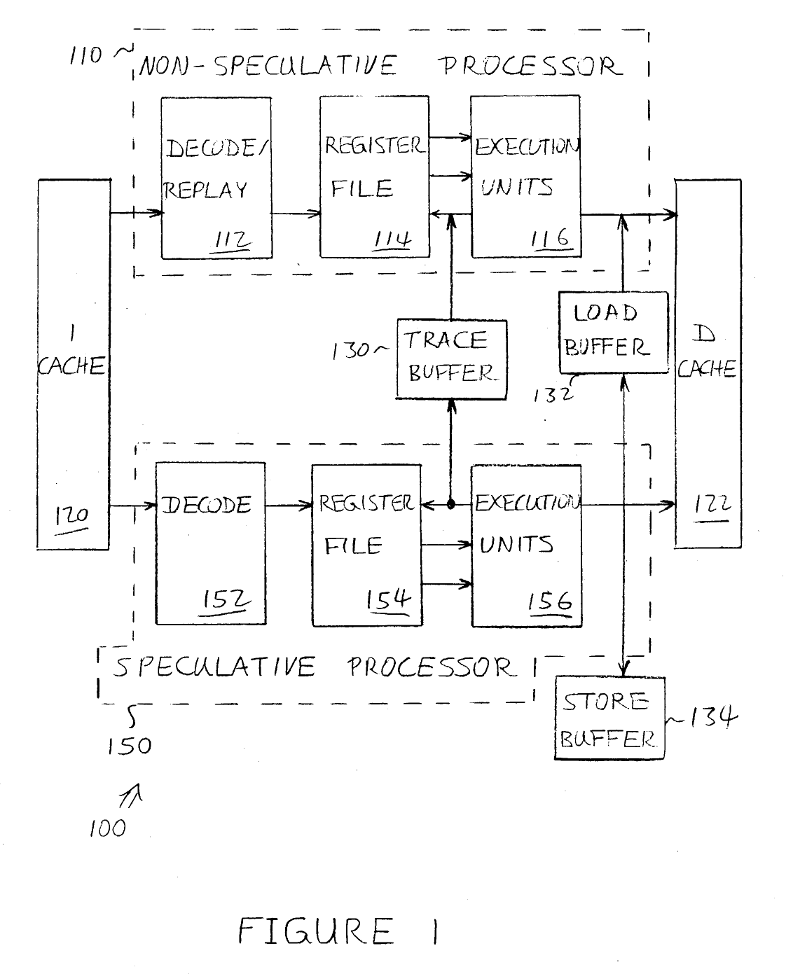

Referring now to FIG. 1, a schematic diagram of an apparatus with a speculative processor 150 and a non-speculative processor 110 is shown, according to one embodiment. In the FIG. 1 embodiment, the speculative processor 150 and non-speculative processor 110 may each have certain functional blocks, but may share resources such as instruction cache 120 and data cache 122. Non-speculative processor 110 may have a combination decode and replay module 112, permitting instruction decoding or, alternatively, replay of instructions speculatively executed in the speculative processor 150. Instructions speculatively executed in the speculative processor 150 may have their results placed into the register file 154 and additionally into trace buffer 130.

Speculative processor 150 should not modify the architectural state of the non-speculative processor 110 and therefore may not commit its results to the register file 114 of non-speculative processor 110, or to system memory. Instead, the speculative processor 110 may accumulate the results for a given thread in trace buffer 130. The results in trace buffer 130 may then be available for reuse by the non-speculative processor 110. Memory communications in the speculative threads may be handled in the store buffer 134, where there may be buffers for each speculative thread context.

When the non-speculative processor 110 reaches the point in a thread where the speculative processor 150 began execution, it may enter a replay mode and start re-using the results from the trace buffer 130. To identify which instructions the non-speculative processor 110 may reuse from trace buffer 130 without re-execution, the non-speculative processor 110 may maintain a list of the registers that it modifies between the starting point of its own execution and the point at which the speculative execution begins. During replay mode, non-speculative processor 110 may re-execute only those instructions whose source operands are derived from one of the modified registers.

In other embodiments, the speculative processor and non-speculative processors may be individual software threads executing on a single hardware processor.

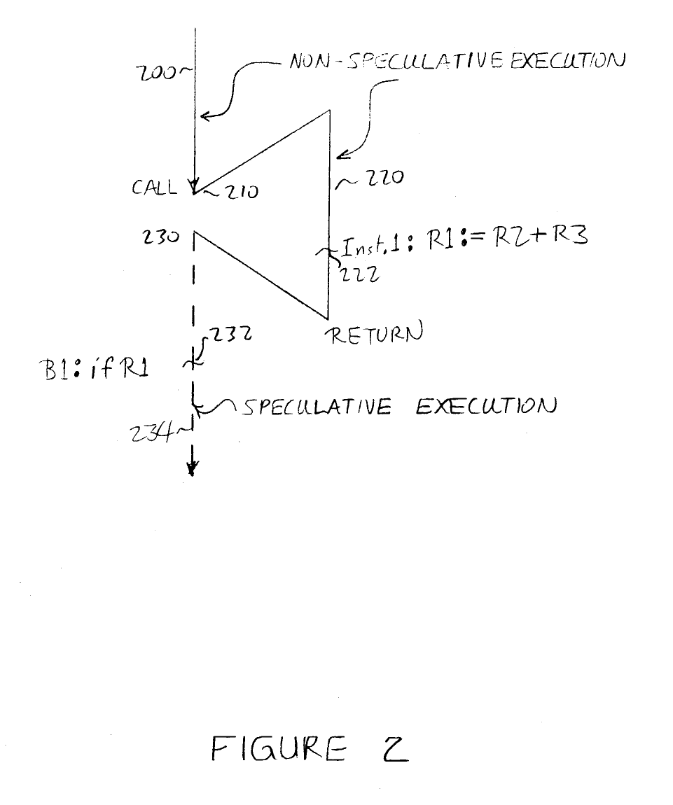

Referring now to FIG. 2, a diagram of speculative processor execution during a non-speculative routine is shown, according to one embodiment. Non-speculative processor execution 200 progresses until it reaches a procedure call point 210. The non-speculative processor execution 220 then takes place in the procedure call. At the time the non-speculative processor execution reaches the procedure call point 210, speculative processor execution may begin at the return point 230, and continue until the non-speculative processor execution reaches the return point 230. Note that all the registers produced in the code region 200 are available for speculative processor execution, while all registers produced in the code region 220 will be unavailable for speculative processor execution.

The unavailability of certain register results causes a problem with speculative processor execution branches which may be illustrated in FIG. 2. At the point of branch B1 232, the branch will be taken if R1 is true and not taken if R1 is false. However, the value of R1 may be modified during the non-speculative execution, at instruction 1 222. There the value of R1 may be changed, making the branch decision based upon speculative processor execution of B1 232 incorrect. Normally the actual execution of a branch instruction, in comparison with a branch prediction made by a branch predictor, should give correct results as to which branch path to take. But in the case of speculative execution, the actual speculative processor execution may give incorrect results.

The incorrect results created by the actual speculative processor execution of branch instructions may occur in other speculative environments than in the FIG. 2 procedure call. In another embodiment, the speculative processor execution may occur in the code subsequent to a loop being performed in a non-speculative processor execution. In another embodiment, the speculative processor execution may occur in the code of a future iteration of a loop being performed in a non-speculative processor execution. In yet another embodiment, the speculative processor execution may occur in the code subsequent to a cache miss in the code being performed in a non-speculative processor execution. In this embodiment, the speculative processor execution may cover all the instructions in the shadow of the load causing the cache miss that are independent of that load.

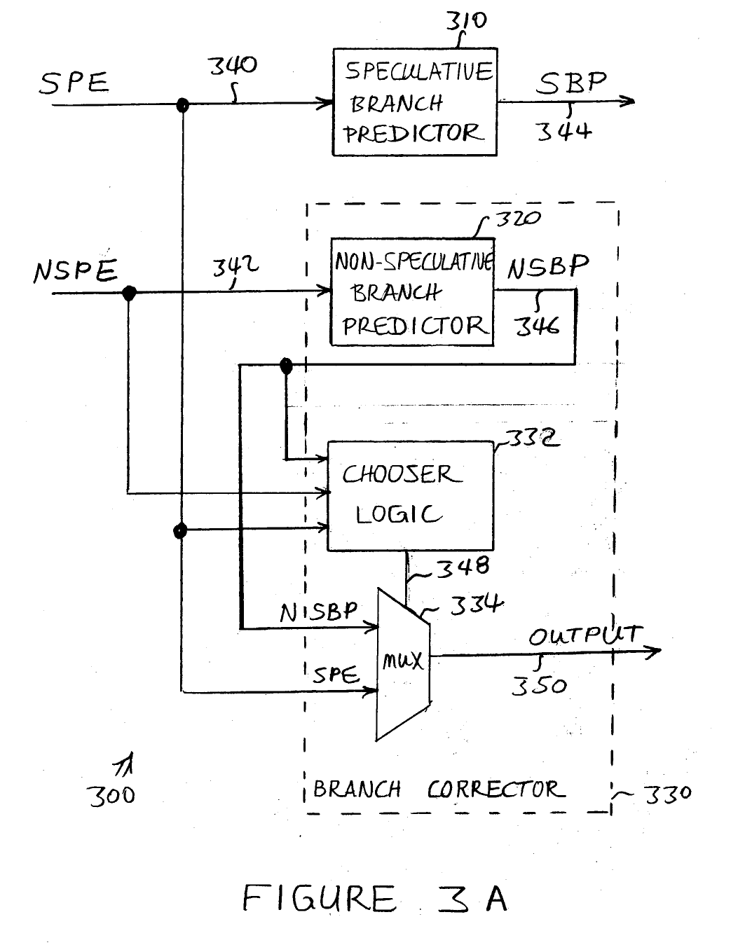

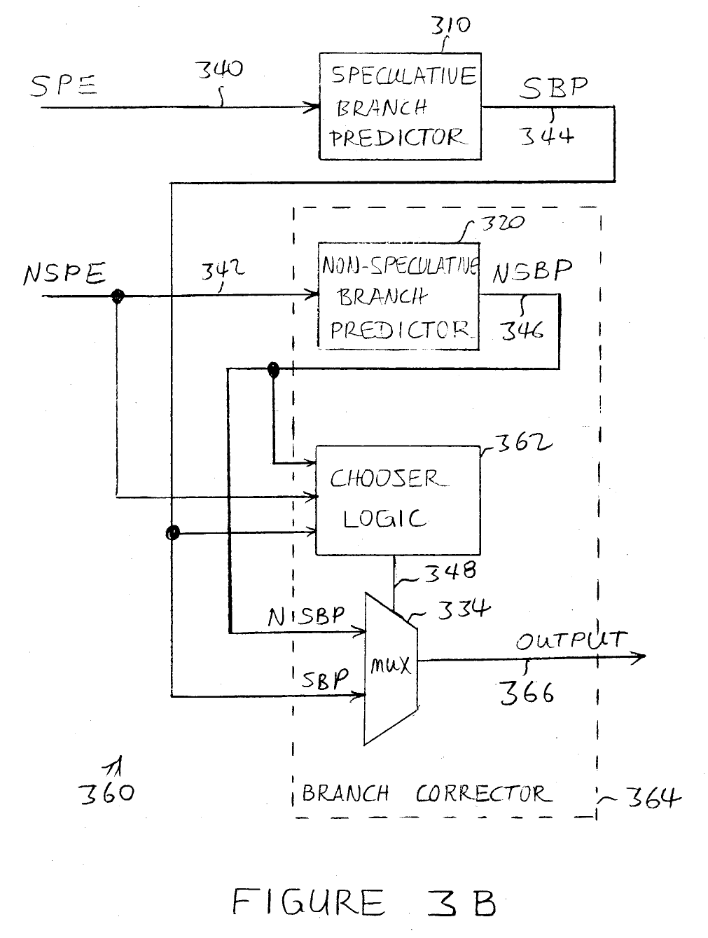

Referring now to FIG. 3, a schematic diagram of a wrong path predictor 300 circuit is shown, according to one embodiment of the present disclosure. A wrong path predictor 300 may be used to reduce the occurrence of incorrect branch decisions made during speculative processor execution. In the FIG. 3 embodiment, the wrong path predictor 300 may include a speculative branch predictor 310 and a branch corrector 330.

Speculative branch predictor 310 may make speculative branch predictions based upon data supplied by the speculative processor's execution of instructions, including branch instructions. In one embodiment, the speculative branch predictor 310 may monitor speculative processor execution over a speculative processor execution signal path 340. The speculative processor execution may train speculative branch predictor 310 over the course of program execution. This history of program execution in the speculative processor may be called speculative processor execution history. The output of speculative branch predictor 310 may indicate a “taken” or “not taken” value on a speculative branch predictor signal path 344. The output may be selected due to an “indexing” related to the current branch address. In one embodiment, indexing may be performed simply by the program counter value of the branch point. In other embodiments, indexing may be performed by using the program counter value of the branch point in light of the procedure call program counter value that spawned the speculative processor execution, or may be performed by using the program counter value of the branch point in light of global history of branch directions (predicted or actual) prior to the branch point.

Speculative branch predictor 310 may implement one of many forms of branch predictor methods well-known in the art, including local-history based, and “gshare” methods. In one embodiment, the speculative branch predictor may use a variant of the gshare method, called the stacked gshare method. As in a regular gshare method, the stacked gshare method may perform an exclusive-or of global branch history bits with the program counter value of the branch instruction to form an index into a pattern history table. The pattern history table may consist of two-bit saturating counters, the most significant bit of which gives the prediction for the Branch. Here the expression “saturating counter” means a counter that does not roll-over at maximum or minimum values, but remains at the maximum value when incremented or at the minimum value when decremented.

The stacked gshare method may differ from the regular gshare method by using global branch history that does not include any branch outcomes from the procedure call. Thus the regular gshare scheme may use a call-aware global branch history, while the stacked gshare scheme may use a call-unaware global history. A speculative processor may execute code after a procedure call while the non-speculative processor may execute code in the procedure call, as shown in FIG. 2 above. Hence the speculative processor may not have branch outcomes from the procedure call computed by the non-speculative processor, which causes gaps in the global branch history seen by the speculative processor. For this reason, a stacked gshare scheme may be beneficial for the speculative processor.

Updating the stacked gshare global branch history bits may require a history stack. When a procedure call is encountered, the global branch history may be pushed onto the history stack. On a return instruction, the history on top of the history stack may be popped. Annotation bits may be added to existing design branch predictors to identify call or return instructions as early in the pipeline as desired. The push/pop of the global branch history may enable the speculative branch predictor 310 to be trained using branch history similar to that seen by the speculative processor. Updating the pattern history table of the stacked gshare may occur during the commit stage of each conditional branch instruction. This update may occur either in the speculative processor or in the non-speculative processor.

The lookup of the stacked gshare may occur in the speculative processor when a branch instruction is encountered and a prediction needs to be made. For this purpose, when a speculative processor thread is spawned (on a call instruction) by the non-speculative processor, the global branch history at that point may be transferred from the non-speculative processor to the speculative branch predictor 310. The speculative branch predictor 310 may use this global branch history to lookup the stacked gshare and continues to build it as it fetches new branches. The speculative branch predictor 310 may have its own history stack, and may push and pop its global branch history when it encounters calls and returns respectively. In general, the stacked gshare scheme may be trained by updating using global branch history similar to that used during lookup.

The wrong path predictor 300 may also include a branch corrector 330. Generally, a branch corrector may determine whether to trust a speculative processor execution outcome (or a speculative branch prediction) over that of a non-speculative branch prediction. In one embodiment, the branch corrector 330 may include a non-speculative branch predictor 320, chooser logic 332, and a multiplexor 334 or other form of switch to select an output from a speculative processor execution signal path 340 or a non-speculative branch prediction signal path 346. The branch corrector 320 output 350 may be used to override the actual speculative processor execution of branch instructions when the non-speculative branch prediction is chosen over the speculative processor execution.

The non-speculative branch predictor 320 may make branch predictions based upon data supplied by the non-speculative processor execution of instructions, including branch instructions. In one embodiment, the non-speculative branch predictor 320 may monitor non-speculative processor execution over a non-speculative processor execution signal path 342. The non-speculative processor execution may train non-speculative branch predictor 320 over the course of program execution. This history of program execution in the non-speculative processor may be called non-speculative processor execution history. The output of non-speculative branch predictor 320 may indicate a “taken” or “not taken” value on a non-speculative branch predictor signal path 346. The output may be selected due to an “indexing” related to the current branch address, and may use one of the indexing methods described above in connection with speculative branch predictor 310.

Non-speculative branch predictor 320 may implement one of many forms of branch predictor methods well-known in the art, discussed above in connection with speculative branch predictor 310. In one embodiment, the non-speculative branch predictor 320 may also use the stacked gshare method. However, it is not necessary that speculative branch predictor 310 and non-speculative branch predictor 320 use the same branch prediction method.

Branch corrector 330 may also include a chooser logic 332 and a mux 334 for selecting an output 350 from either a non-speculative branch predictor signal path 346 or from a speculative processor execution signal path 340. In one embodiment, chooser logic 332 produces a select signal on select signal path 348 to control mux 334. In one embodiment, chooser logic 332 may produce this select signal based upon non-speculative processor execution history, non-speculative branch prediction history, and speculative processor execution history. These histories may be gathered by storing information received on non-speculative processor execution signal path 342, non-speculative branch prediction signal path 346, and speculative processor execution signal path 340. In one embodiment, the chooser logic 332 causes mux 334 to generally select the speculative processor execution as the outcome (result) of true branch execution unless histories within chooser logic indicate that, for the branch under consideration, the speculative processor execution generally did not match the non-speculative processor execution, and that the non-speculative branch prediction generally matched the non-speculative processor execution. In this case, the non-speculative branch prediction would be chosen as the outcome (result) of true branch execution.

In another embodiment, wrong path predictor 300 may add hysteresis to the prediction tables of speculative branch predictor 310 and non-speculative branch predictor 320.

Referring now to FIG. 3B, a schematic diagram of a wrong path predictor circuit 360 is shown, according to another embodiment of the present disclosure. In the FIG. 3B embodiment, the speculative branch predictor 310, non-speculative branch predictor 320, and mux 334 may be any of the corresponding embodiments discussed in connection with FIG. 3A. However, in the FIG. 3B embodiment, the branch corrector 364 may include a new chooser logic 362 and mux 334 that may select between a speculative branch prediction and a non-speculative branch prediction rather than the non-speculative branch prediction and speculative processor execution as shown in FIG. 3A.

Chooser logic 362 may produce a select signal on select signal path 348 to control mux 334. In one embodiment, chooser logic 362 may produce this select signal based upon non-speculative branch prediction history, non-speculative processor execution history, and speculative branch prediction history. These histories may be gathered by storing information received on non-speculative branch prediction signal path 346, non-speculative processor execution signal path 342, and speculative branch prediction signal path 344.

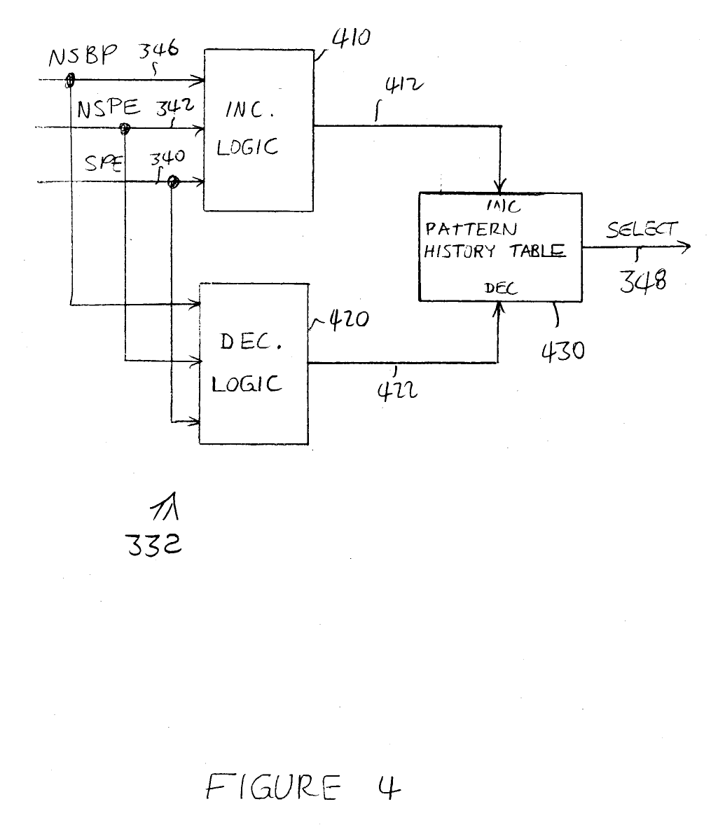

Referring now to FIG. 4, a schematic diagram of a chooser logic 332 of FIG. 3A is shown, according to one embodiment of the present disclosure. A pattern history table 430 is established to store summarized histories of branch predictions and executions. In one embodiment, pattern history table 430 may include a set of saturating counters indexed to the branch points. The saturating counters may be incremented by an incrementing logic 410 or decremented by a decrementing logic 420. In one embodiment, incrementing logic 410 may increment an indexed counter when a speculative processor execution does not match a non-speculative processor execution for a given instance of a branch, and when a non-speculative branch prediction does match that non-speculative processor execution for that same instance of the branch. In one embodiment, decrementing logic 410 may decrement an indexed counter when a speculative processor execution does match a non-speculative processor execution for a given instance of a branch, and when a non-speculative branch prediction does not match that non-speculative processor execution for that same instance of the branch. In other embodiments, other decisions could be evaluated to determine whether to increment or decrement an indexed counter, as in the other signals used in chooser logic 362 of the FIG. 3B embodiment.

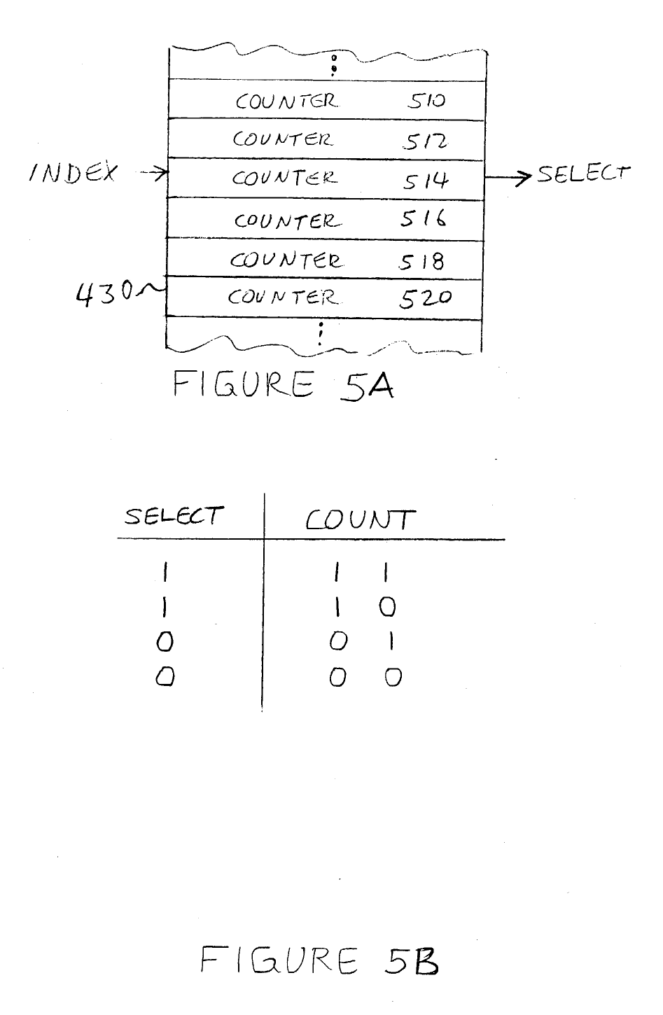

Referring now to FIG. 5A, a diagram of a pattern history table 430 of FIG. 4 is shown, according to one embodiment of the present disclosure. In one embodiment, the saturating counters, of which saturating counters 510 through 520 are shown, are addressed by an index. In one embodiment, indexing may be performed simply by the program counter value of the branch point under consideration. In other embodiments, indexing may be performed by using the program counter value of the branch point in light of the procedure call program counter value that spawned the speculative processor execution, or may be performed by using the program counter value of the branch point in light of global history of branch directions (predicted or actual) prior to the branch point.

Referring now to FIG. 5B, a logic table of a counter 514 of FIG. 5A is shown, according to one embodiment of the present disclosure. Here the counter 514 is shown as a two-bit saturating counter. In other embodiments, there could be more or fewer bits in the counter. The two bits may be concatenated as shown to give a select value based upon the count value. If the count value is either 11 or 10, then the select value is 1, causing mux 348 to select the non-speculative branch prediction. If the count value is either 01 or 00, then the select value is 0, causing mux 348 to select the speculative processor execution. For embodiments with more bits in the counter, an extended form of concatenation may be used.

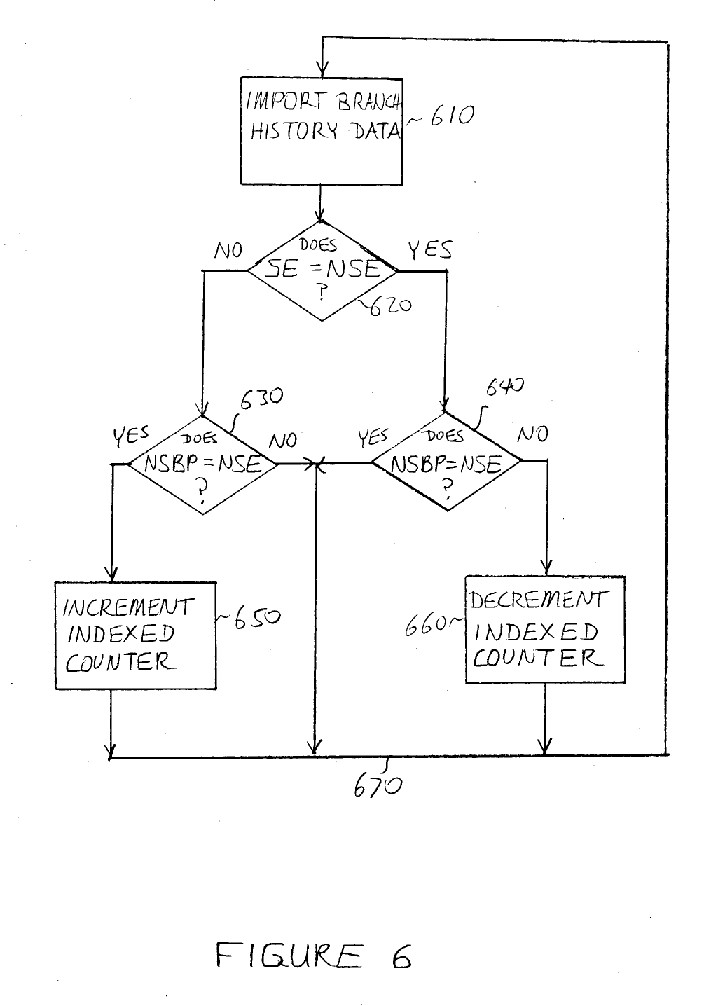

Referring now to FIG. 6, a flowchart of determining how to train a wrong path predictor is shown, according to one embodiment of the present disclosure. In block 610, information concerning branch executions and branch predictions is gathered. In decision block 620, it is determined whether the speculative processor execution of a particular instance of a branch matches the non-speculative processor execution of that same instance of the branch. If there is a match, then the process exits via the YES path of decision block 620 and enters decision block 640. In decision block 640, it is determined whether the non-speculative branch prediction of a particular instance of a branch matches the non-speculative processor execution of that same instance of the branch. If there is no match, then the process exits via the NO path of decision block 640, and in block 660 the process decrements the indexed counter. If there is a match, then the process exits via the YES path of decision block 640, and no further action is taken. The process returns to block 610 for more information.

However, if there is not a match in decision block 620, then the process exits via the NO path of decision block 620 and enters decision block 630. In decision block 630, it is determined whether the non-speculative branch prediction of a particular iteration of a branch matches the non-speculative processor execution of that iteration of the branch. If there is a match, then the process exits via the YES path of decision block 630, and in block 650 the process increments the indexed counter. If there is not a match, then the process exits via the NO path of decision block 640, and no further action is taken. The process returns to block 610 for more information.

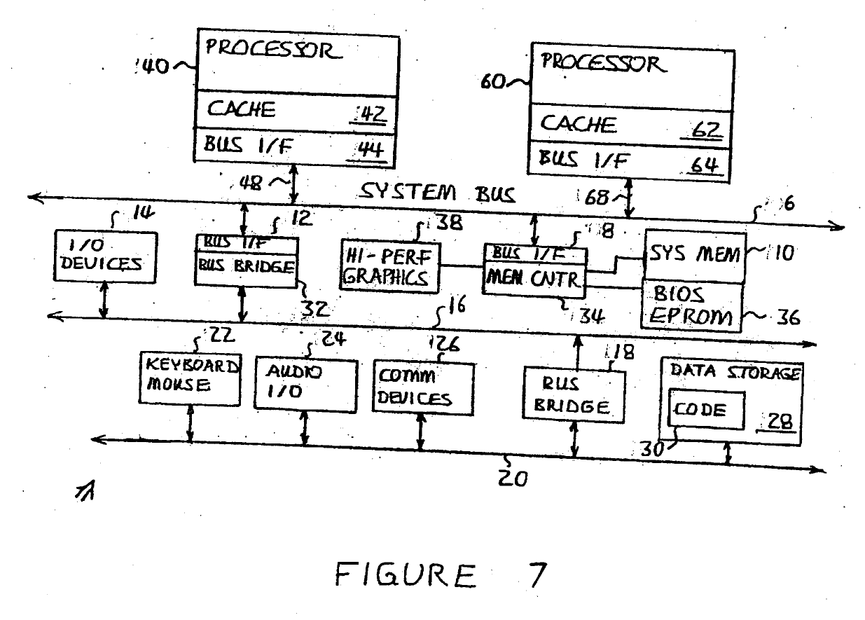

Referring now to FIG. 7, a schematic diagram of a microprocessor system is shown, according to one embodiment of the present disclosure. The FIG. 7 system may include several processors of which only two, processors 40, 60 are shown for clarity. Processors 40, 60 may be the apparatus 100 of FIG. 1, including non-speculative processor 110 and speculative processor 150. Processors 40, 60 may include caches 42, 62. The FIG. 7 multiprocessor system may have several functions connected via bus interfaces 44, 64, 12, 8 with a system bus 6. In one embodiment, system bus 6 may be the front side bus (FSB) utilized with Itanium® class microprocessors manufactured by Intel® Corporation. A general name for a function connected via a bus interface with a system bus is an “agent”. Examples of agents are processors 40, 60, bus bridge 32, and memory controller 34. In some embodiments memory controller 34 and bus bridge 32 may collectively be referred to as a chipset. In some embodiments, functions of a chipset may be divided among physical chips differently than as shown in the FIG. 7 embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface, or an AGP interface operating at multiple speeds such as 4×AGP or 8×AGP. Memory controller 34 may direct read data from system memory 10 to the high-performance graphics circuit 38 across high-performance graphics interface 39.

Bus bridge 32 may permit data exchanges between system bus 6 and bus 16, which may in some embodiments be a industry standard architecture (ISA) bus or a peripheral component interconnect (PCI) bus. There may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a speculative processor to produce a speculative processor execution outcome; and
a branch corrector, to determine whether to trust said speculative processor execution outcome.

2. The apparatus of claim 1, wherein said branch corrector determines to trust said speculative processor execution outcome using a non-speculative branch predictor trained by a non-speculative processor to produce a non-speculative branch prediction.

3. The apparatus of claim 2, wherein said branch corrector chooses between said non-speculative branch prediction and said speculative processor execution outcome at branch resolution time.

4. The apparatus of claim 3, wherein a non-speculative processor execution outcome, said non-speculative branch prediction, and said speculative processor execution outcome are used to modify a counter.

5. The apparatus of claim 4, wherein said counter is indexed by a branch program counter.

6. The apparatus of claim 4, wherein said counter is indexed by a branch program counter in light of a program counter, wherein said program counter is selected from the group comprising a procedure call program counter, a loop entry program counter, and a loop exit program counter.

7. The apparatus of claim 4, wherein said counter is indexed by a branch program counter in light of global history of the directions of other branches.

8. The apparatus of claim 3, wherein said branch corrector chooses said non-speculative branch prediction based upon said speculative processor execution outcome and said non-speculative processor execution outcome having many mismatches.

9. The apparatus of claim 8, wherein said branch corrector further chooses said non-speculative branch prediction based upon said non-speculative processor execution outcome and said non-speculative branch prediction having many matches.

10. The apparatus of claim 3, wherein said branch corrector chooses said speculative processor execution outcome based upon said speculative processor execution outcome and said non-speculative processor execution outcome having many matches.

11. The apparatus of claim 10, wherein said branch corrector further chooses said speculative processor execution outcome based upon said non-speculative processor execution outcome and said non-speculative branch prediction having many mismatches.

12. The apparatus of claim 2, further comprising a speculative branch predictor trained by said speculative processor execution outcome to produce a speculative branch prediction, wherein said branch corrector additionally chooses between said non-speculative branch prediction and said speculative branch prediction in the front-end.

13. The apparatus of claim 12, wherein a non-speculative processor execution outcome, said non-speculative branch prediction, and said speculative branch prediction are used to modify a counter.

14. The apparatus of claim 13, wherein said counter is indexed by a branch program counter.

15. The apparatus of claim 13, wherein said counter is indexed by a branch program counter in light of a program counter, wherein said program counter is selected from the group comprising a procedure call program counter, a loop entry program counter, and a loop exit program counter.

16. The apparatus of claim 13, wherein said counter is indexed by a branch program counter in light of global history of the directions of other branches.

17. The apparatus of claim 12, wherein said branch corrector chooses said non-speculative branch prediction based upon said speculative branch prediction and said non-speculative processor execution outcome having many mismatches.

18. The apparatus of claim 17, wherein said branch corrector further chooses said non-speculative branch prediction based upon said non-speculative processor's execution outcome and said non-speculative branch prediction having many matches.

19. The apparatus of claim 12, wherein said branch corrector chooses said speculative branch prediction based upon said speculative branch prediction and said non-speculative processor's execution outcome having many matches.

20. The apparatus of claim 19, wherein said branch corrector further chooses said speculative branch prediction based upon said non-speculative processor execution outcome and said non-speculative branch prediction having many mismatches.

21. The apparatus of claim 2, wherein said non-speculative branch predictor utilizes gshare branch prediction.

22. The apparatus of claim 2, wherein said non-speculative branch predictor utilizes local history based branch prediction.

23. The apparatus of claim 2, wherein said non-speculative branch predictor utilizes stacked gshare based branch prediction

24. The apparatus of claim 1, wherein said speculative branch predictor utilizes gshare branch prediction.

25. The apparatus of claim 1, wherein said speculative branch predictor utilizes local history based branch prediction.

26. The apparatus of claim 1, wherein said speculative branch predictor utilizes stacked gshare based branch prediction.

27. A method, comprising:
producing a speculative branch prediction;
producing a non-speculative branch prediction history;
receiving a speculative processor execution outcome; and
choosing between said non-speculative branch prediction and said speculative processor's execution outcome.

28. The method of claim 27, wherein said choosing includes choosing based upon non-speculative processor execution outcome, said non-speculative branch prediction and said speculative processor execution outcome.

29. The method of claim 28, wherein said choosing includes choosing said non-speculative branch prediction based upon said speculative processor execution outcome and said non-speculative processor execution outcome having many mismatches.

30. The method of claim 29, wherein said choosing further includes choosing said non-speculative branch prediction based upon said non-speculative processor execution outcome and said non-speculative branch prediction having many matches.

31. The method of claim 28, wherein said choosing includes choosing said speculative processor execution outcome based upon said speculative processor execution outcome and said non-speculative processor execution outcome having many matches.

32. The method of claim 31, wherein said choosing further includes choosing said speculative processor execution outcome based upon said non-speculative processor execution outcome and said non-speculative branch prediction having many mismatches.

33. An apparatus, comprising:
means for producing a speculative branch prediction;
means for producing a non-speculative branch prediction;
means for receiving a speculative processor execution outcome; and
means for choosing between said non-speculative branch prediction and said speculative processor execution outcome.

34. The apparatus of claim 33 wherein said means for choosing includes means for choosing based upon a non-speculative processor execution outcome, said non-speculative branch prediction and said speculative processor execution outcome.

35. The apparatus of claim 34, wherein said means for choosing includes means for choosing said non-speculative branch prediction based upon said speculative processor execution outcome and said non-speculative processor execution outcome having many mismatches.

36. The apparatus of claim 35, wherein said means for choosing further includes means for choosing said non-speculative branch prediction based upon said non-speculative processor execution outcome and said non-speculative branch prediction having many matches.

37. The apparatus of claim 34, wherein said means for choosing includes means for choosing said speculative processor execution outcome based upon said speculative processor execution outcome and said non-speculative processor execution outcome having many matches.

38. The apparatus of claim 37, wherein said means for choosing further includes means for choosing said speculative processor execution outcome based upon said non-speculative processor execution outcome and said non-speculative branch prediction having many mismatches.

39. A system, comprising:
a speculative processor to produce a speculative processor execution outcome;
a branch corrector, to determine whether to trust said speculative processor execution outcome;
a system bus coupled to said speculative processor and said branch corrector; and
a graphics controller coupled to said system bus.

40. The system of claim 39, wherein said branch corrector includes a non-speculative branch predictor trained by a non-speculative processor to produce said non-speculative branch prediction.

41. The system of claim 39, wherein said branch corrector additionally chooses between non-speculative branch prediction and speculative branch prediction in the front-end.

42. The system of claim 39, wherein said non-speculative branch prediction, said non-speculative processor execution outcome, and said speculative processor execution outcome are used to modify a counter.
